(19) United States
(12) Patent Application Publication
(10) Pub. No.: US 2020/0361452 A1
(43) Pub. Date: Nov. 19, 2020

(54) VEHICLES AND METHODS FOR PERFORMING TASKS BASED ON CONFIDENCE IN ACCURACY OF MODULE OUTPUT

(71) Applicant: Toyota Research Institute, Inc., Los Altos, CA (US)

(72) Inventors: Stephen G. McGill, Broomall, PA (US); Guy Rosman, Newton, PA (US); Luke S. Fletcher, Cambridge, MA (US)

(73) Assignee: Toyota Research Institute, Inc., Los Altos, CA (US)

(21) Appl. No.: 16/410,460

(22) Filed: May 13, 2019

(51) Int. Cl. B60W 30/09; B60W 50/04; B60W 50/02; B60W 50/10; B60W 30/095; B60W 30/18; B60W 30/12

(52) U.S. Cl. CPC B60W 30/09; B60W 50/045; B60W 50/0205; B60W 30/12; B60W 30/0953; B60W 30/0956; B60W 30/18163; B60W 50/10

(57) ABSTRACT

An embodiment takes the form of a method carried out by a vehicle. The vehicle identifies a prospective task to be performed by the vehicle, and obtains a confidence in an accuracy of an output of a module. The vehicle determines that the obtained confidence exceeds a threshold confidence that is associated with the prospective task, and in response to determining that the obtained confidence exceeds the threshold confidence, performs the prospective task.

### TECHNICAL FIELD

The present disclosure generally relates to vehicles and methods carried out by vehicles, and more specifically, to vehicles and methods for performing a prospective task based on a confidence in an accuracy of a module output.

### BACKGROUND

To perform a given task, a vehicle may use the output of a vehicle module. For example, an autonomous vehicle may perform a lane change based on the predicted trajectories of another vehicle as determined by a trajectory predictor. However, if the module provides inaccurate output, the task may be performed in an improper or undesirable manner.

### SUMMARY

An embodiment of the present disclosure takes the form of a method carried out by a vehicle. The vehicle identifies a prospective task to be performed by the vehicle, and obtains a confidence in an accuracy of an output of a module. The vehicle determines that the obtained confidence exceeds a threshold confidence that is associated with the prospective task, and in response to determining that the obtained confidence exceeds the threshold confidence, performs the prospective task.

Another embodiment takes the form of a vehicle that includes a processor and a non-transitory computer-readable storage medium that includes instructions. The instructions, when executed by the processor, cause the vehicle to identify a prospective task to be performed by the vehicle and obtain a confidence in an accuracy of an output of a module. The instructions further cause the vehicle to determine that the obtained confidence exceeds a threshold confidence that is associated with the prospective task, and in response to determining that the obtained confidence exceeds the threshold confidence, perform the prospective task.

A further embodiment takes the form of a method carried out by a vehicle. The vehicle identifies a prospective task to be performed by the vehicle, and obtains a confidence in an accuracy of an output of a module. The vehicle makes a determination whether the obtained confidence exceeds a threshold confidence that is associated with the prospective task. If the determination is that the obtained confidence exceeds the threshold confidence, the vehicle performs the prospective task. If the determination is that the obtained confidence does not exceed the threshold confidence, the vehicle performs an alternative task different from the prospective task.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIGS. 1a and 1b depict an example operation of a vehicle, according to one or more embodiments described and illustrated herein;

FIG. 2 depicts a block diagram of an ego vehicle, according to one or more embodiments described and illustrated herein;

FIG. 3 depicts a flowchart of a method carried out by a vehicle, according to one or more embodiments described and illustrated herein;

FIG. 4 depicts example modules of a vehicle, according to one or more embodiments described and illustrated herein;

FIG. 5 depicts a table identifying modules associated with prospective tasks that may be performed by a vehicle, according to one or more embodiments described and illustrated herein;

FIG. 6 depicts a table identifying modules associated with prospective tasks that may be performed by a vehicle in one or more contexts, according to one or more embodiments described and illustrated herein;

FIG. 7 depicts a table indicating respective threshold confidences and risks associated prospective tasks, according to one or more embodiments described and illustrated herein;

FIG. 8 depicts a table indicating respective threshold confidences and risks associated prospective tasks in one or more indicated contexts, according to one or more embodiments described and illustrated herein; and

FIG. 9 depicts a flowchart of a method carried out by a vehicle, according to one or more embodiments described and illustrated herein.

### DETAILED DESCRIPTION

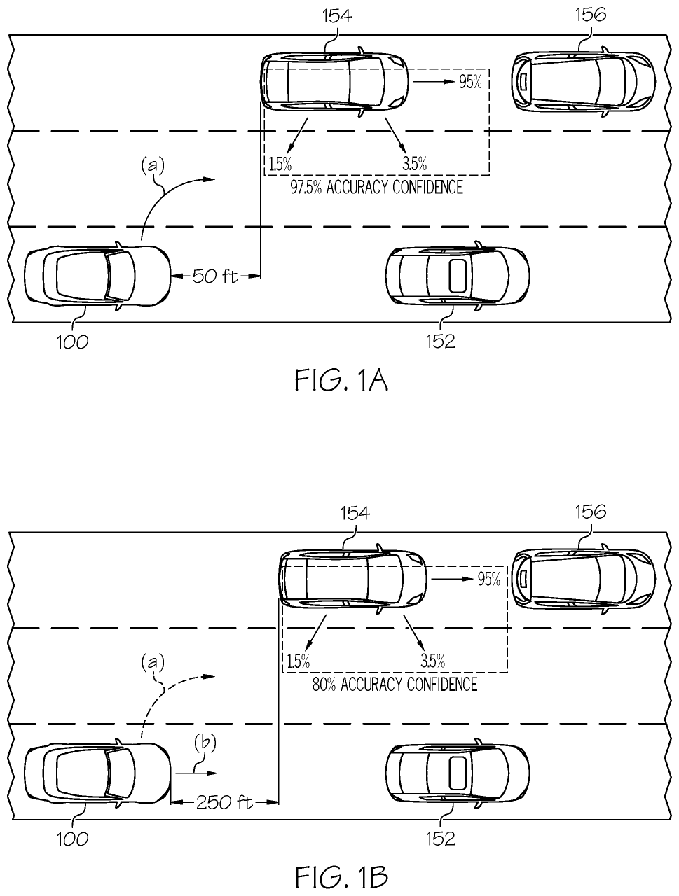

FIGS. 1a and 1b depict an example operation of a vehicle 100, according to one or more embodiments described and illustrated herein. As shown in FIG. 1a, vehicle 100 (also referred to as the “ego vehicle”) is traveling in a straight direction in the right lane of a three-lane road. Vehicle 100 is approaching another vehicle 152 traveling in a straight direction in the same lane as vehicle 100. Also traveling on the three-lane road are vehicles 154 and 156, both traveling in a straight direction in the left lane. In this example, vehicle 100 is an autonomous vehicle, and vehicle 100 determines that it is to pass vehicle 152 by changing lanes into the middle lane. Vehicle 100 changing lanes is referred to in this example as the “prospective task.”

Performance of the prospective task may require or depend on output from a module of the vehicle. Examples of such modules include a module to predict a trajectory of the ego vehicle (e.g., if the ego vehicle is a manually-operated or semi-autonomous vehicle), a module to predict a trajectory of one or more road agents (such as vehicles 152, 154, and/or 156), and a module to determine the location or presence of one or more road agents around the ego vehicle. The output of such modules could include one or more predicted trajectories of vehicle 100, one or more predicted trajectories of vehicles 152, 154, and/or 156, and a determined location or presence of one or more road agents, among other possibilities. In FIG. 1a, vehicle 100 performing the lane change may require predicted trajectories of vehicles 152, 154, and 156, as output by a road-agent trajectory predictor, so that vehicle 100 can determine a trajectory (a) for the lane change. In the embodiment shown in FIG. 1a, vehicle 100 requires the respective probabilities that vehicle 154 will take one of three illustrated trajectories (including maintaining a current trajectory and changing lanes), and obtains and output of a road-agent trajectory predictor indicating 95%, 3.5%, 1.5% probabilities that vehicle 154 will take the respective trajectories.

However, the accuracy of the output of a given module may not be absolute, and the accuracy of the output of some modules may, on average, be greater than the accuracy of the output of other modules. This may be a result of, for example, limited computational and electrical power of the ego vehicle, and of multiple systems and modules sharing these resources. To balance resource consumption, different modules may use respectively different amounts of resources. For example, a low-power variant of a road-agent detection module may determine the location of a road agent with medium accuracy, while a high-power variant may determine the location with high accuracy. The low-power variant of the road-agent detection module may use fewer resource than the high-power variant, but may also be less accurate on average than the high-power variant.

Accordingly, to perform the prospective task, vehicle 100 may require a given level of confidence in the accuracy of the output of a given module. In the embodiment of FIG. 1a, to perform the lane change, vehicle 100 requires a 95% confidence in the accuracy of the predicted trajectories of vehicle 154 as output by the road-agent trajectory predictor. As shown in FIG. 1a, vehicle 100 determines that it is 97.5% confident in the accuracy of the predicted trajectories output by the road-agent trajectory predictor. Because the 97.5% confidence exceeds the required 95% confidence, vehicle 100 performs the lane change.

However, not every prospective task requires the same confidence in the accuracy of the output of a module. Rather, the required confidence may depend on the task and, for example, the risk that performance of the task poses to allowable operation of the ego vehicle.

For example, a high-risk task may require a higher confidence in the accuracy of the output of a given module. To illustrate, as shown in FIG. 1a, the longitudinal distance between vehicle 100 and vehicle 154 is only 50 feet (i.e., vehicle 154 is only 50 feet in front of vehicle 100). The collision horizon in this example is two seconds: based on the longitudinal distance and the current speeds, trajectories etc. of vehicle 100 and vehicle 154, these two vehicles could collide in as few as two seconds if the speeds, trajectories, etc. were to deviate substantially from those predicted by, for instance, the road-agent trajectory predictor. These two seconds may provide relatively little time for vehicle 100 (or the driver of vehicle 100) to react and perform a maneuver to avoid a collision with vehicle 154. Given this relatively low amount of time to react, a 97.5% confidence in the accuracy of the output of a trajectory predictor is required. Because of this higher confidence requirement, vehicle 100 may use a higher-power variant of the road-agent trajectory predictor, which may consume more resources but may be generally more accurate than the lower-power predictor.

Conversely, a low-risk task may require a lower confidence. To illustrate, in FIG. 1b, the longitude distance between vehicle 100 and vehicle 154 is 250 feet—significantly more than the 50 feet in FIG. 1a. Based on this longitudinal distance and the trajectories, speeds, etc. of vehicles 100 and 154, the collision horizon is six seconds, much more than the two seconds in FIG. 1a. Given the greater amount of time for vehicle 100 (or the driver of vehicle 100) to react, only a 85% confidence in the accuracy of the road-agent trajectory predictor is required. Because of this relatively low required confidence, vehicle 100 may use a lower-power variant of the road-agent trajectory predictor, which may be generally less accurate than other variants of the road-agent trajectory predictor, but which may consume fewer resources than the other variants.

If the confidence in the accuracy of the output of a module is less than a required confidence, vehicle 100 may perform an alternative (e.g., remedial) task. For instance, if in FIG. 1b, vehicle 100 is attempting to perform a lane change based on a low-power variant of the road-agent trajectory predictor, and the confidence in the accuracy of the output of this low-power variant is only 80%, then vehicle 100 may switch to a high-power variant. If the confidence in the accuracy of the output of this high-power variant exceeds the required 85% confidence, then vehicle 100 may perform the lane change. If not, vehicle 100 could try an even higher-power variant of the road-agent trajectory predictor, or could instead determine to maintain a current trajectory (b) instead of changing lanes.

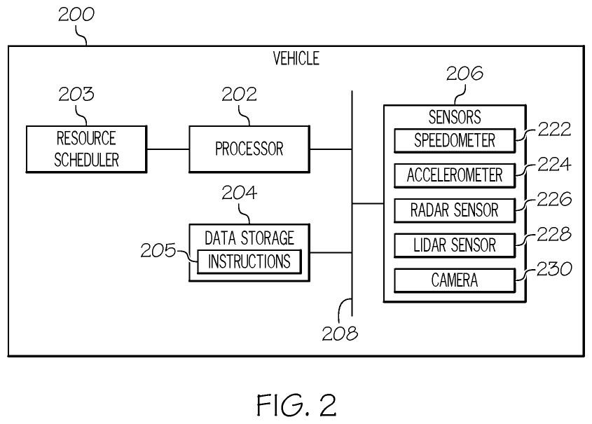

FIG. 2 depicts a block diagram of an ego vehicle, according to one or more embodiments described and illustrated herein. As shown, a vehicle 200 includes a processor 202, a data storage 204, and sensors 206, each of which are communicatively connected by a communication path 208.

The processor 202 may be any device capable of executing computer-readable instructions 205 stored in the data storage 204. The processor 202 may take the form of a general purpose processor (e.g., a microprocessor), a special purpose processor (e.g., an application specific integrated circuit), an electronic controller, an integrated circuit, a microchip, a computer, or any combination of one or more of these, and may be integrated in whole or in part with the data storage 204 or any other component of the vehicle 200, as examples. In some embodiments, the vehicle 200 includes a resource scheduler 203 configured to assign resources for executing the instructions 205. For example, the processor 202 may be configured to execute multiple threads or processes of instructions 205, and the resource scheduler 203 may be configured to assign resources (such as time or cycles of the processor 202) for executing the respective threads and processes. If the instructions 205 are subject to a real-time constraint, then the resource scheduler 203 may be configured to assign resources for executing the instructions before an execution deadline of the constraint.

The data storage 204 may take the form of a non-transitory computer-readable storage medium capable of storing the instructions 205 such that the instructions can be accessed and executed by the processor 202. As such, the data storage 204 may take the form of RAM, ROM, a flash memory, a hard drive, or any combination of these, as examples. The instructions 205 may comprise logic or algorithm(s) written in any programming language of any generation (e.g., 1GL, 2GL, 3GL, 4GL, or 5GL) such as, for example, machine language that may be directly executed by the processor 202, or assembly language, object-oriented programming (OOP), scripting languages, microcode, etc., that may be compiled or assembled into machine readable instructions and stored in the data storage 204. Alternatively, the instructions 205 may be written in a hardware description language (HDL), such as logic implemented via either a field programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. While the embodiment depicted in FIG. 2 includes a single data storage 204, other embodiments may include more than one.

The sensors 206 could take the form of one or more sensors operable to detect information for use by the vehicle 200, including information regarding operation of the vehicle and the environment of the vehicle, as examples. Though the sensors 206 may be referenced in the plural throughout this disclosure, those of skill in the art will appreciate that the sensors 206 may take the form of (or include) a single sensor or multiple sensors. In the embodiment illustrated in FIG. 2, the sensors 206 include a speedometer 222, an accelerometer 224, a radar sensor 226, a lidar sensor 228, and a camera 230. The sensors may be positioned anywhere on the vehicle, including an interior of the vehicle and/or an exterior of the vehicle. In some embodiments, the sensors are configured to detect information continuously—for example, in real-time such that information can be provided to one or more components of the vehicle with little or no delay upon detection of the information by the sensor or upon a request for the detected information from a component of the vehicle.

The speedometer 222 and the accelerometer 224 may be used to detect a speed and an acceleration of the vehicle 200, respectively. The radar sensor 226, the lidar sensor 228, and/or the camera 230 may be mounted on an exterior of the vehicle and may obtain signals (such as electromagnetic radiation) that can be used by the vehicle to detect objects in the environment of the vehicle. For example, the radar sensor and/or the lidar sensor may send a signal (such as pulsed laser light or radio waves) and may obtain a distance measurement from the sensor to the surface of an object based on a time of flight of the signal—that is, the time between when the signal is sent and when the reflected signal (reflected by the object surface) is received by the sensor. The camera may collect light or other electromagnetic radiation and may generate an image representing a perspective view of the environment of the vehicle based on the collected radiation. The obtained signals and/or generated image can be used by the vehicle to, for example, determine the presence, location, or trajectory of one or more objects, including a road agent such as a pedestrian, bicycler, or another vehicle, as examples.

The communication path 208 may be formed from any medium that is capable of transmitting a signal such as, for example, conductive wires, conductive traces, optical waveguides, or the like. The communication path 208 may also refer to the expanse in which electromagnetic radiation and their corresponding electromagnetic waves traverses. Moreover, the communication path 208 may be formed from a combination of mediums capable of transmitting signals. In one embodiment, the communication path 208 comprises a combination of conductive traces, conductive wires, connectors, and buses that cooperate to permit the transmission of electrical data signals to and from the various components of the vehicle 200. Accordingly, the communication path 208 may comprise a bus. Additionally, it is noted that the term “signal” means a waveform (e.g., electrical, optical, magnetic, mechanical or electromagnetic) capable of traveling through a medium such as DC, AC, sinusoidal-wave, triangular-wave, square-wave, vibration, and the like.

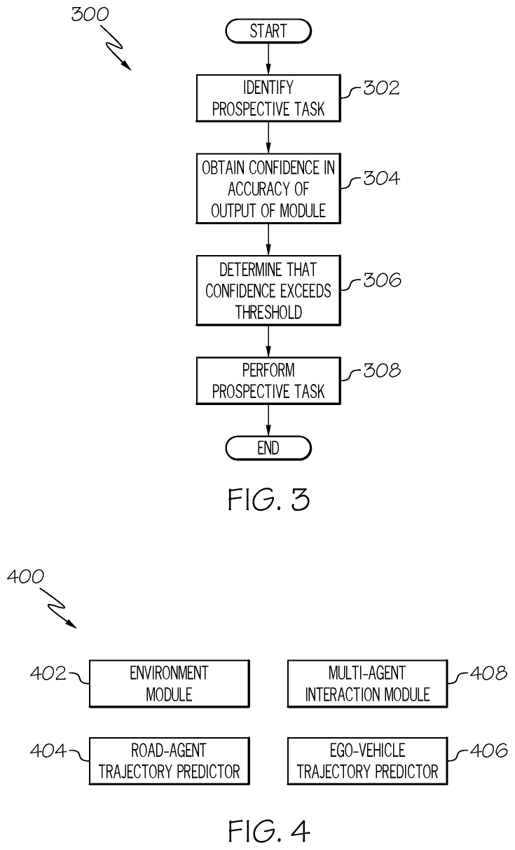

FIG. 3 depicts a flowchart of a method carried out by a vehicle, according to one or more embodiments described and illustrated herein. As shown, a method 300 begins at step 302 with the vehicle 200 identifying a prospective task to be performed by the vehicle 200. Many variations of the prospective task are possible. For example, the prospective task may include the vehicle 200 taking a given trajectory, which could include maintaining a current trajectory or taking a trajectory different from a current trajectory, among other possibilities. The trajectory could take the form of a turn such as a right turn, a left turn, a soft left turn, etc. However, the trajectory need not correspond to any discrete or categorized notion of a turn or maneuver. As another example, the prospective task may include an obstacle avoidance maneuver—e.g., to prevent the vehicle 200 from colliding with an object present on the road ahead of the vehicle 200. As a further example, the prospective task may include changing a speed or acceleration of the vehicle 200, or maintaining a current speed or acceleration of the vehicle 200. Those of skill in the art will appreciate that these prospective tasks are not mutually exclusive of each other, and that performing a given task (such as an obstacle avoidance maneuver) may involve performing another one or more of these tasks (such as taking a given trajectory) or other tasks.

Identifying the prospective task may take one or more forms based on a type of the vehicle 200. For instance, identifying the prospective task may involve the vehicle 200 determining to perform a given task. As one possibility, the vehicle 200 may take the form of an autonomous or semi-autonomous vehicle, and identifying the prospective task may involve the (semi-)autonomous vehicle determining to take a given trajectory. As another possibility, if the vehicle 200 takes the form of a manually-operated vehicle or semi-autonomous vehicle, then then identifying the prospective task could involve detecting an action of the driver of the vehicle and predicting that the driver is attempting to cause the vehicle to perform the prospective task based on the detected action. For example, the vehicle 100 may detect that the driver is beginning to rotate a steering wheel to the right (e.g., while at an intersection) and may predict that the driver is attempting to cause the vehicle to make a right turn based on the detected rotation. The vehicle 100 could accordingly identify the prospective task as a right turn.

The vehicle 200 may include one or more modules, and identifying the prospective task may involve identifying the prospective task based on output from the one or more modules. To illustrate, FIG. 4 depicts example modules of the vehicle 200, according to one or more embodiments described and illustrated herein. As shown, the vehicle 200 includes an environment module 402, a road-agent trajectory predictor 404, an ego-vehicle trajectory predictor 406, and a multi-agent interaction module 408. The modules may assist the vehicle 200 with performing one or more vehicle functions, and could take the form of one or more hardware modules, one or more software modules, or any combination of these, as examples. For instance, the modules may assist the vehicle 200 with predicting a trajectory of the vehicle 200 (e.g., if the vehicle 200 is a manually-operated or semi-autonomous vehicle), predicting the trajectory of a road agent, or identifying obstacles, objects, or potential hazards along an (actual or predicted) trajectory of the vehicle 200, as examples.

The environment module 402 may operate to output information regarding the environment of the vehicle 200—e.g., based on data obtained from the sensors 206. For instance, the environment module 402 may obtain data from the radar sensor 226, the lidar sensor 228, and/or the camera 230, to determine or predict the presence or location of one or more road agents or other objects around the vehicle 200, and may output the predicted or determined locations of the road agents or objects.

The road-agent trajectory predictor 404 and the ego-vehicle trajectory predictor 406 may operate to output a predicted trajectory of the vehicle 200 and a road agent, respectively. The prediction may be based on, for example, a location, speed, or acceleration of the vehicle 200 or the road agent, or previous trajectories of the vehicle 200 or the road agent. The output of the road-agent trajectory predictor 404 could include a most likely trajectory, or multiple predicted trajectories with associated probabilities, among other possibilities. The road-agent trajectory predictor 404 could include (or take the form of) a turn predictor operable to output a predicted trajectory in the form of a discrete turn of the road agent. In an embodiment, the output of the road-agent trajectory predictor 404 takes the form of a distribution of predicted trajectories, and each predicted trajectory in the distribution may be associated with a respective probability that the road agent will take the predicted trajectory. Other outputs are possible as well, as will be understood by one of skill in the art. The ego-vehicle trajectory predictor 406 may operate to output a predicted trajectory (or trajectories) of the vehicle 200, and may function in a manner similar to the road-agent trajectory predictor 404.

The multi-agent interaction module 408 may operate to output predicted group phenomena of the vehicle 200 and one or more road agents. For example, the multi-agent interaction module 408 may predict the behavior of the vehicle 200 based on the behavior of the road agent (or vice versa), or may predict the behavior of a given road agent based on the behavior of another road agent, among other possibilities.

A given module may include one or more variants of the module. For example, as described above, a given module may include a low-power variant, which may consume fewer resources but may generally provide less-accurate output, and a high-power variant, which may generally provide more-accurate output but may consume more resources that the low-power variant.

Referring again to FIG. 3, identifying the prospective task may involve the vehicle 200 obtaining an output from a given module and, based on the output, determining to perform a given task. For example, the vehicle 200 may obtain output from the environment module 402 indicating that a stationary object is present on the road ahead of the vehicle 200 and, based on the indicated presence of the stationary object, determine to perform an obstacle avoidance maneuver (e.g., if the vehicle is an autonomous or semi-autonomous vehicle).

If the vehicle 200 is a manually-operated or semi-autonomous vehicle, then identifying the prospective task could involve detecting an action of the driver of the vehicle, obtaining an output from a given module, and predicting, based on both the detected action and the output of the module, that the driver is attempting to cause the vehicle 200 to perform the prospective task. For example, the vehicle 200 may detect that the driver is changing a trajectory of the vehicle 200 (e.g., by changing a steering wheel angle) and may obtain output from the environment module 402 indicating that a stationary object is present on the road ahead of the vehicle 200. Based on both the detected change in trajectory and the obtained output indicating the presence of the stationary object, the vehicle 200 may predict that the driver is attempting to cause the vehicle 200 to perform an obstacle avoidance maneuver, and may identify that obstacle avoidance maneuver as the prospective task.

The vehicle 200 may identify the prospective task based on a context of the vehicle 200, which in turn may be based on output from one or more modules of the vehicle 200 or data received from the sensors 206, as examples. The context may indicate, for instance, that a stationary object is present on the road ahead of the vehicle 200, or that the vehicle 200 is traveling at a given speed based on data received from the speedometer 222. Moreover, the context may be based on a synthesis of output from one or more modules and data received from the sensors 206. As an illustration, the context may indicate that the collision horizon of the vehicle 200 is a given time horizon based on a location of a road agent indicated by output from the environment module 402, a predicted trajectory of the road agent indicated by the output from the road-agent trajectory predictor 404, and a speed of the vehicle 200 indicated by data received from the speedometer 222. The vehicle 200 may determine the context of the vehicle 200 based on this information, and may identify the prospective task based on the identified context.

At step 304, the vehicle 200 obtains a confidence in an accuracy of an output of a module. For example, the vehicle 200 could obtain a confidence of “high” in an accuracy of a predicted trajectory output by the road-agent trajectory predictor 404, or a confidence of “2.1” in an accuracy of a road agent location output by the environment module 402. The output could include, for example, a predicted trajectory of the vehicle 100, a road agent, and/or multiple road agents, among other possibilities.

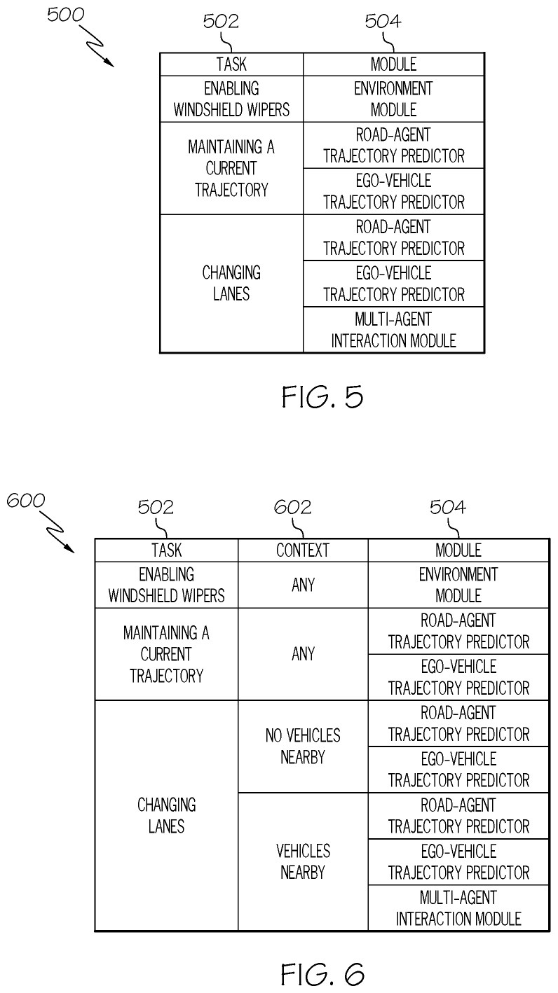

The module (of which the vehicle 200 obtains the confidence in the accuracy of the output) may be based on the prospective task identified by the vehicle 200 at step 302. To illustrate, FIG. 5 depicts a table 500 identifying the modules of the vehicle that are associated with prospective tasks that may be performed by the vehicle 200, according to one or more embodiments described and illustrated herein. As shown, a column 502 identifies several prospective tasks that may be performed by the vehicle 200, and a column 504 identifies one or more modules of the vehicle 200 associated with each respective task. In the illustrated embodiment, the “environment module” 402 is associated with the prospective task of “enabling windshield wipers” of the vehicle 200. If the vehicle 200 were to later enable the windshield wipers of the vehicle 200, then the vehicle 200 may perform this task based on output of the environment module 402. For instance, the vehicle 200 may enable or set a speed of the windshield wipers based on an amount of precipitation indicated by the output of the environment module 402. As such, if the vehicle 200 were to identify the prospective task as enabling the windshield wipers, then the vehicle 200 may obtain a confidence in the accuracy of the output of the environment module 402.

The vehicle 200 may obtain a confidence in an accuracy of an output of each of several modules of the vehicle 200. The modules of which the vehicle 200 obtains the confidence may be based on the prospective task identified by the vehicle 200. For example, in the embodiment illustrated in FIG. 5, both the “road-agent trajectory predictor” 404 and the “ego-vehicle trajectory predictor” 406 are associated with the prospective task of “maintaining a current trajectory” of the vehicle 200. If the vehicle 200 were to later maintain a current trajectory (the prospective task), then the vehicle 200 may perform this task based on an output of both the road-agent trajectory predictor 404 and the ego-vehicle trajectory predictor 406. Accordingly, if at step 302, the vehicle 200 were to identify the prospective task as maintaining the current trajectory of the vehicle 200, then at step 304, the vehicle may obtain a confidence in the accuracy of the output of both the road-agent trajectory predictor 404 and the ego-vehicle trajectory predictor 406. Similarly, as illustrated in FIG. 5, if the vehicle 200 were to identify the prospective task as “changing lanes,” then the vehicle 200 may obtain a confidence in the accuracy of the output of the road-agent trajectory predictor 404, the ego-vehicle trajectory predictor 406, and the multi-agent interaction module 408.

In some embodiments, the module (or modules) of which the vehicle 200 obtains the confidence in the accuracy of the output may be based on a context of the prospective task identified by the vehicle 200. To illustrate, FIG. 6 depicts a table 600 identifying the modules of the vehicle 200 that are associated with prospective tasks that may be performed by the vehicle 200 in one or more identified contexts, according to one or more embodiments described and illustrated herein. A column 602 identifies one or more contexts in which one or more of the prospective tasks identified by column 502 may be performed. Each identified context of a given prospective task is associated with one or more modules of the vehicle 200, as identified by column 504. In the illustrated embodiment, the prospective task of “changing lanes” has a context of “no nearby vehicles” in which the prospective task may be performed, as well as a context of “vehicles nearby” in which the prospective task may be performed. It should be understood, however, that a given prospective task need not be associated with any specific context. For example, as shown in FIG. 6, the prospective tasks of “enabling windshield wipers” and “maintaining a current trajectory” are both associated with “any” context.

In an embodiment, the vehicle 200 selects a module of the vehicle 200 based on the identified prospective task, and obtaining the confidence in the accuracy of the output of a module includes obtaining the confidence in the accuracy of the output of the selected module. In some embodiments, the vehicle 200 selects the module based on data stored in the data storage 204. For example, the data storage 204 may include data in the form of the table 500 illustrated in FIG. 5, and the vehicle 200 may select the module based on the table represented by the data. In some embodiments, the vehicle 200 selects the module based on a context of the prospective task identified by the vehicle 200. In such embodiments, the data storage 204 may include data in the form of the table 600 illustrated in FIG. 6, and the vehicle 200 may select the module based on the table represented by this data.

Various forms of the obtained confidence are possible. For example, the obtained confidence could be “high”, “medium”, or “low”, or a variation of these (such as “somewhat high” or “very low”). As another possibility, the obtained confidence could be a number within a given range of numbers—e.g., on a scale of 0 to 10, with 0 indicating the lowest confidence and 10 indicating the highest confidence. Higher numbers could represent a higher accuracy, or could represent a lower accuracy. Additionally, the number could take the form of an integer, a decimal, or other form, and could be positive, negative, or zero (e.g., if the number is a rational number). Moreover, the obtained confidence could be any variation of these or other forms, as will be understood by those of skill in the art.

The obtained confidence in the accuracy of the output of the module may be a confidence in an accuracy of a discrete output of a module, or a confidence in an accuracy of all actual or prospective output of the module, among other possibilities. In an embodiment, each predicted trajectory in a distribution of predicted trajectories (e.g., as indicated by output of the road-agent trajectory predictor 404 and/or the ego-vehicle trajectory predictor 406) is associated with a respective probability that the vehicle 200 and/or a road agent will take the predicted trajectory, and the confidence in the accuracy of the output of the module includes a confidence in an accuracy of the distribution indicated by the output of the module.

The confidence may reflect a confidence in the module accurately mapping and associating input to the module with output of the module. For example, different modules of the vehicle may consume respectively different amounts of computational or other resources to generate output. A module that uses fewer resources (e.g., a power-conserving module or low-priority module) may operate faster or consume fewer resources than other modules, but may not map or associate input to the module with output of the module with as high of an accuracy as other modules (e.g., modules that consume more resources). On the other hand, a module that consumes more resources or operates slower than other modules may more-accurately map or associate input to the module with output of the module, but may also leave fewer resources for other modules to use (perhaps resulting in a lower confidence in the accuracy of the output of these other modules). Accordingly, a confidence in an accuracy of an output of a module may reflect an amount of resources allocated to or consumed by the module, or a speed with which the module is able to operate, as examples.

The obtained confidence in the accuracy of the output of the module may reflect a confidence in an accuracy of input to the module, upon which actual or prospective output of the module may be based. This confidence may reflect a confidence in an accuracy of a discrete input to the module, or a confidence in one or more sensors 206 or other modules providing accurate input to the module, among other possibilities. As an example, the confidence may reflect a confidence that a given sensor is functioning properly, or that the sensor is providing accurate input to the module based on a current context of the vehicle 200. For instance, if there is abundant sunlight outside of the vehicle 200, then a high confidence may reflect a confidence that the camera 230 is providing an image accurately representing the environment of the vehicle 200, as well as a high confidence in an accuracy of a module that is based on the accurate input provided to the module by the camera 230. On the other hand, if there is little or no sunlight outside of the vehicle 200, then the vehicle 200 may obtain a low confidence, reflecting little confidence that the image accurately represents the environment of the vehicle and little confidence in an output of a module that is based on this inaccurate input to the module.

The obtained confidence in an accuracy of an output of a module may reflect a confidence that the module is receiving a sufficient amount of input to generate accurate output. For example, if predicted trajectories of a road agent, as output by the road-agent trajectory predictor 404, are based on trajectories previously taken by that road agent, and only one or a few trajectory samples of the trajectories taken by the road agent have been collected by the vehicle 200 and received by the road-agent trajectory predictor 404, then the vehicle 200 may obtain a low confidence in the accuracy of the output of the road-agent trajectory predictor 404, because so few trajectory samples may be insufficient to accurately predict a trajectory of a road agent.

The obtained confidence in the accuracy of the output of the module may be based on a comparison of the output of the module with data of a known accuracy—for example, by determining a similarity between the output of the module and data known to be accurate. For example, the data storage 204 may store accurate data (e.g., data with corresponding indications of accuracy), and the confidence in the accuracy of the output of the module may be based on a similarity between the output and the accurate data.

Obtaining a confidence in an accuracy of an output of a module may involve obtaining a confidence in an accuracy of one or more aspects upon which the accuracy of the output is based, which in turn could involve obtaining measurements or other indications of these one or aspects. For example, if a confidence in an accuracy of a location of a road agent (as output by the environment module 402) is based on a confidence in the camera 230 providing an image accurately representing the environment of the vehicle 200, then obtaining the confidence in the accuracy of the output of the environment module 402 may involve obtaining an indication of an amount of sunlight or other light outside of the vehicle 200—e.g., from a photodiode of the vehicle 200 or from the camera 230 itself. If a confidence in an accuracy of an output is based on an amount of resources allocated to or used by the module, then obtaining the confidence in the accuracy of the output may involve obtaining an indication of the allocated amounts of those resource—e.g., from the resource scheduler 203 or the data storage 204. If the module is subject to a real-time constraint, then obtaining the confidence in the accuracy of the output of the module may involve obtaining an indication of a deadline of the constraint from the resource scheduler 203. The vehicle 200 may then determine a confidence in the accuracy of the output based on the obtained one or more indications.

At step 306, the vehicle 200 determines that the confidence obtained at step 304 exceeds a threshold confidence associated with the prospective task identified at step 302. The determination could involve a determination that an indication of the obtained confidence exceeds an indication of the threshold confidence, and the indication of the threshold confidence could take a form discussed above with reference to the indication of the obtained confidence. Thus, the indication of the threshold could be “low”, “very high”, “2”, or “7.9”, as examples.

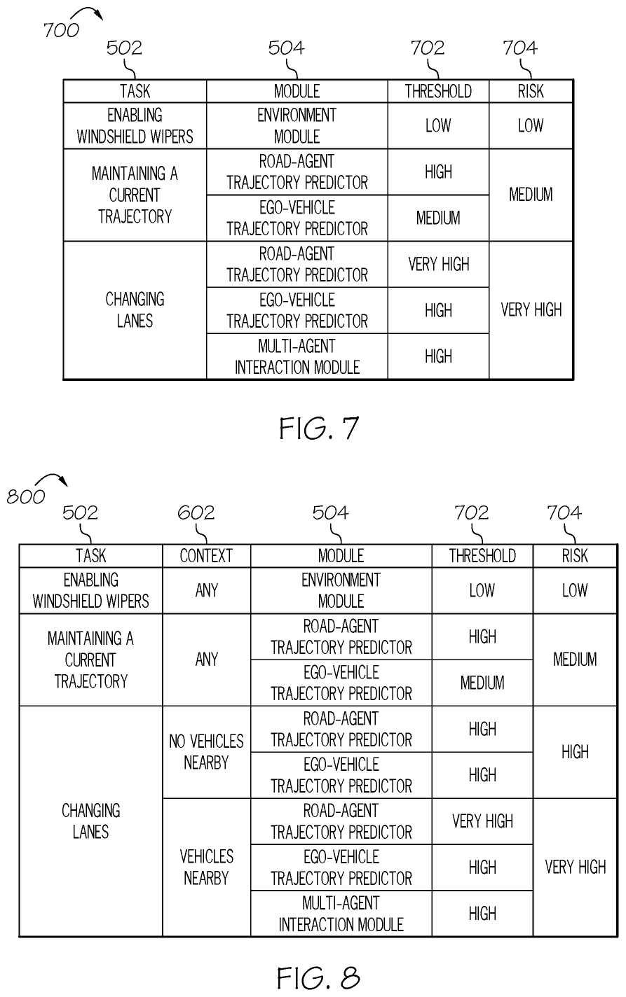

The threshold confidence may be based on a risk that performance of the prospective task may pose to allowable operation of the vehicle 200. For example, FIG. 7 depicts a table 700 indicating a respective threshold confidence and risk associated with each of a plurality of prospective tasks, according to one or more embodiments described and illustrated herein. As shown, each of the tasks identified in column 502 has at least one threshold confidence 702 associated with the respective task, as well as a risk 704 that performance of the respective task may pose to allowable operation of the vehicle 200. For instance, performance of the prospective task of “enabling windshield wipers” of the vehicle 200 poses a “low” risk to allowable operation of the vehicle, and has a “low” threshold confidence associated with the prospective task. On the other hand, performance of the prospective task of “maintaining a current trajectory” of the vehicle 200 poses a “medium” risk to allowable operation of the vehicle 200, and performance of the prospective task of “changing lanes” poses a “very high” risk to allowable operation of the vehicle 200.

In an embodiment, the threshold confidence associated with the prospective task takes the form of a threshold confidence in an accuracy of an output of a module associated with the prospective task. To illustrate, as shown in FIG. 7, each prospective task identified in column 502 is associated with one or more modules identified in column 504. A column 702 identifies a respective threshold confidence in an accuracy of an output of each module associated with each prospective task. For example, in the embodiment shown in FIG. 7, the “environment module” 402 is associated with the task of “enabling windshield wipers,” and the threshold confidence of “low” associated with the enabling the windshield wipers takes the form of a low threshold confidence in an accuracy of an output of the environment module 402. Additionally, as shown in FIG. 7, the threshold confidence associated with the prospective task may take the form of a respective threshold confidence in an accuracy of an output of each of a plurality of modules associated with the prospective task. For example, in the embodiment shown in FIG. 7, the “road-agent trajectory predictor” 404 and the “ego-vehicle trajectory predictor” 406 are associated with the task of “maintaining a current trajectory,” and the threshold confidences of “high” and “medium” associated with the task take the form of high and medium threshold confidences in the accuracy of the output of the road-agent trajectory predictor 404 and the ego-vehicle trajectory predictor 406, respectively. Similarly, the “road-agent trajectory predictor” 404, the “ego-vehicle trajectory predictor” 406, and the “multi-agent interaction module” 408 are associated with the task of “changing lanes,” and the threshold confidences of “very high,” “high,” and “high” associated with the task take the form of very high, high, and high threshold confidences in the accuracy of the output of the road-agent trajectory predictor 404, the ego-vehicle trajectory predictor 406, and the multi-agent interaction module 408, respectively.

The threshold confidence associated with a prospective task may take the form of a threshold confidence in an accuracy of an output of a module associated with a given context of the prospective task. For example, FIG. 8 depicts a table 800 indicating a respective threshold confidence and risk associated with prospective tasks that may be performed by the vehicle 200 in one or more indicated contexts, according to one or more embodiments described and illustrated herein. As shown, each of the prospective tasks identified in column 502 has at least one context identified in column 602, indicating (for example) a context in which the respective prospective task may be performed. As indicated in a column 704, each context of a given prospective task has a respective risk that performance of the prospective task in the context may pose to allowable operation of the vehicle 200.

To illustrate, in the embodiment shown in FIG. 8, the prospective task of “changing lanes” has a context “no nearby vehicles” in which the prospective task may be performed, as well as a context of “vehicles nearby” in which the prospective task may be performed. The risk that performance of changing lanes poses to allowable operation of the vehicle 200 when no other vehicles are nearby is “high,” and the risk when other vehicles are nearby is “very high.” In the former case, the collision horizon may be greater since a road agent (if present) is not nearby, allowing the vehicle 200 (or driver of the vehicle) to react to any sudden behaviors of the road agent that could result in a collision between the vehicle 200 and the road agent, and thus posing a lower risk to collision-free operation. In the latter case, however, the collision horizon may be shorter, allowing the driver less time to react, and thus posing a greater risk to collision-free operation.

Additionally, each context of a given prospective task shown in FIG. 8 has at least one module (identified in column 504) associated with the respective context, and each module of a given context of the prospective task is associated with a respective threshold confidence identified in a column 702, which indicates a threshold confidence in an accuracy of an output of the respective module associated with the given context of the given prospective task.

To illustrate, in the embodiment shown in FIG. 8, the “road-agent trajectory predictor” 404 and the “ego-vehicle trajectory predictor” 406 are associated with the context “no vehicles nearby” of the prospective task “changing lanes.” The “multi-agent interaction module” 408, in addition to the road-agent trajectory predictor 404 and the ego-vehicle trajectory predictor 406, are associated with the context “vehicles nearby” of the same prospective task “changing lanes.” The road-agent trajectory predictor 404 and the ego-vehicle trajectory predictor 406 associated with the context “no vehicles nearby” of the prospective task “changing lane” are themselves associated with “high” and “high” threshold confidences, indicating high threshold confidences in an accuracy of an output of both the road-agent trajectory predictor 404 and the ego-vehicle trajectory predictor 406. The road-agent trajectory predictor 404, the ego-vehicle trajectory predictor 406, and the multi-agent interaction module 408—associated with the context “vehicles nearby” of the prospective task “changing lane”—are associated with “very high,” “high,” and “high” threshold confidences, indicating very high, high, and high threshold confidences in an accuracy of an output of the road-agent trajectory predictor 404, the ego-vehicle trajectory predictor 406, and the multi-agent interaction module 408, respectively.

However, the threshold confidence associated a given prospective task need not be associated with any specific context of the prospective task. For example, as illustrated in FIG. 8, a threshold confidence of “low” associated with the prospective task of “enabling windshield wipers” is more particularly associated with “any” context of this prospective task. Additionally, the threshold confidence associated with a given module and prospective task need not be associated with any specific context of the prospective task. As illustrated in FIG. 8, a threshold confidence of “medium” and “high” associated with the prospective task of “maintaining a current trajectory,” and associated with the road-agent trajectory predictor 404 and the ego-vehicle trajectory predictor 406 (respectively), are associated with “any” context of the prospective task.

At step 308, in response to determining that the obtained confidence exceeds the threshold confidence at step 306, the vehicle 200 performs the prospective task identified at step 302. For example, if the vehicle 200 at step 302 identified the prospective task as the vehicle changing lanes, then at step 308, the vehicle 200 performs the lane change.

Performing the prospective task may include causing the vehicle 200 to perform the prospective task. For example, in an embodiment, identifying the prospective task at step 302 includes the vehicle 200 determining to perform the prospective task. For example, the vehicle 200 may take the form of an autonomous or semi-autonomous vehicle, and the vehicle may obtain output from the environment module 402 indicating that a stationary object is present on the road ahead of the vehicle 200. In such a case, the vehicle 200 may identify the prospective task as an obstacle avoidance maneuver by determining to perform the obstacle maneuver in response to detecting the presence of the object. In such an embodiment, performing the prospective task at step 308 includes the causing the vehicle to perform the prospective task that the vehicle determined to perform at step 302. For example, performing the prospective task may involve causing vehicle 200 to autonomously or semi-autonomously performing the obstacle maneuver that the vehicle 200 determined to perform at step 302.

It should be noted that, even if vehicle 200 determines to perform a prospective task, if the vehicle 200 determines at step 306 that the confidence obtained at step 304 does not exceed the threshold confidence associated with the prospective task, then the vehicle 200 may not perform the prospective task. That is, a vehicle “determining” to perform a given prospective task does not necessarily result in the vehicle “performing” the prospective task, as will be described in further detail below.

Performing the prospective task may include allowing the vehicle 200 to perform the prospective task. For example, in an embodiment, the vehicle 200 takes the form of a semi-autonomous vehicle, and the vehicle 200 identifies the prospective task by detecting an action of the driver of the vehicle 200 and predicting that the driver is attempting to cause the vehicle to perform the prospective task—e.g., changing lanes. In such an embodiment, performing the prospective task at step 308 includes allowing the vehicle 200 to perform the prospective task that the vehicle predicted the driver is attempting to perform. For example, performing the prospective task may include allowing the vehicle 200 to change lanes as predicted at step 302 (e.g., by not engaging a semi-autonomous steering correction to cause the vehicle 200 not to change lanes).

Performing the prospective task may involve the vehicle 200 performing the prospective task based on the output of which the vehicle 200 obtained the confidence in the accuracy at step 304. In an example, the vehicle 200 identifies the prospective task at step 302 as changing lanes. As shown in FIG. 7, the road-agent trajectory predictor 404, the ego-vehicle trajectory predictor 406, and the multi-agent interaction module 408 are associated with the prospective task of changing lanes. Accordingly, at step 304, the vehicle 200 obtains a respective confidence in an accuracy of an output of each of these three modules. In this example, the obtained confidence for the modules are “extremely high,” “very high,” and “very high,” respectively. At step 306, the vehicle 200 determines that the obtained “extremely high” confidence in the accuracy of the output of the road-agent trajectory predictor 404 exceeds the “very high” threshold confidence associated with this module (which in turn is associated with the prospective task of changing lanes). Additionally, at step 306, the vehicle determines that the obtained “very high” and “very high” confidences in the accuracy of the output of the ego-vehicle trajectory predictor 406 and the multi-agent interaction module 408, respectively, exceed the “high” and “high” threshold confidences associated with these modules. At step 308, in response to determining that the obtained confidences exceed the respective thresholds, the vehicle 200 performs the lane change based on the output of the associated modules. By determining that the confidences in the accuracy of the output of the modules exceed the respective thresholds, the probability that performance of the prospective task will adversely affect allowable operation of the vehicle 200 may be decreased.

In an embodiment, in response to determining that the obtained confidence does not exceed the threshold confidence, the vehicle 200 performs an alternative task different from the prospective task.

The alternative task could include increasing the accuracy of the output of the module. In an example, the vehicle 200 identifies the prospective task at step 302 as maintaining a current trajectory. As shown in FIG. 7, the road-agent trajectory predictor 404 and the ego-vehicle trajectory predictor 406 are associated with the prospective task of maintaining a current trajectory. Accordingly, at step 304, the vehicle 200 obtains a respective confidence in an accuracy of an output of each both modules. In this example, the obtained confidences for the modules are “very high” and “low,” respectively. At step 306, the vehicle 200 determines that the obtained “very high” confidence in the accuracy of the output of the road-agent trajectory predictor 404 exceeds the “high” threshold confidence associated with this module and prospective task. However, the vehicle 200 also determines that the obtained “low” confidence in the accuracy of the output of the ego-vehicle trajectory predictor 406 does not exceed the “medium” threshold confidence associated with this module and task. In response to determining that the obtained confidence in the accuracy of the output of the ego-vehicle trajectory predictor 406 does not exceed the threshold confidence, the vehicle 200 performs an alternative task different from maintaining the current trajectory—which in this example includes increasing the accuracy of the output of the ego-vehicle trajectory predictor 406.

Increasing the accuracy of the output of the module may involve, for example, increasing an amount of resources allocated to or used by the module. For example, the vehicle 200 may increase the accuracy by configuring resource scheduler 203 to increase an amount of computational resources, CPU time, CPU cores, memory, or data storage allocated to or used by the module. As another possibility, increasing the accuracy may involve configuring the resource scheduler 203 to maximize a throughput of the module, or minimize a wait time, latency, or response time of the module. If the module is subject to a real-time constraint, then increasing the accuracy may involve configuring the resource scheduler 203 to adjust (e.g., postpone) a deadline of the constraint. As a further possibility, if the module comprises more than one variant of the module, then increasing the accuracy of the output of the module may involve switching to a different variant such as a higher-power variant, as described above. As still another possibility, the alternative task could include performing the prospective task based on an output of a different module.

The alternative task could include preventing the vehicle 200 from performing the prospective task. In an example, the vehicle 200 identifies the prospective task at step 302 as changing lanes by detecting an action of the driver of the vehicle 200 and predicting that the driver is attempting to cause the vehicle to change lanes. At step 304, the vehicle 200 obtains a “high” confidence in an accuracy of the road-agent trajectory predictor 404, and the vehicle 200 subsequently determines that the obtained “high” confidence does not exceed the “very high” threshold confidence associated with this prospective task and module (as shown in FIG. 7). In response to determining that the obtained confidence does not exceed the threshold confidence, the vehicle 200 prevents the vehicle from performing the prospective task—which in this example involves preventing the vehicle from changing lanes (perhaps by engaging a semi-autonomous steering correction to cause the vehicle 200 not to change lanes).

In an embodiment, the prospective task includes taking a prospective trajectory, and performing the alternative task includes causing the vehicle 200 to take an alternative trajectory different from the prospective trajectory. For instance, if the prospective trajectory is a soft right turn, then the vehicle may take an alternative trajectory by instead taking a hard right turn or maintaining a current trajectory, as examples. If the vehicle 200 identifies the prospective task at step 302 by predicting that the driver is attempting to cause the vehicle 200 take the prospective trajectory, then performing the alternative task could involve causing the vehicle 200 to take an alternative trajectory different from the prospective trajectory.

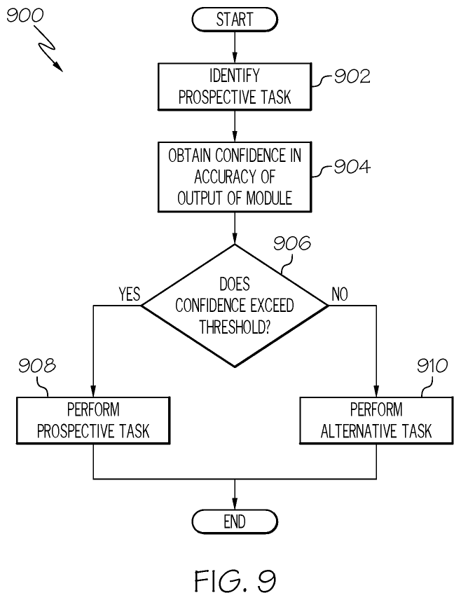

FIG. 9 depicts a flowchart of a method carried out by a vehicle, according to one or more embodiments described and illustrated herein. As shown, a method 900 begins at step 902 with the vehicle 200 identifying a prospective task to be performed by the vehicle 200. At step 904, the vehicle 200 obtains a confidence in an accuracy of an output of a module. Vehicle 200 may carry out steps 902 and 904 as discussed above with reference to steps 302 and 304, respectively.

At step 906, the vehicle 200 makes a determination whether the confidence obtained at step 904 exceeds a threshold confidence associated with the prospective task identified at step 902—e.g., as described above with reference to step 306. If the determination is that the confidence obtained at step 904 exceeds a threshold confidence, then vehicle 200 at step 908 performs the prospective task in response to making this determination, as described above with reference to step 308. On the other hand, if the vehicle 200 the determination is that the obtained confidence does not exceed the threshold, then the vehicle 200 performs an alternative task different from the prospective task in response to making this determination, as described above.

It should now be understood that embodiments described herein are directed to vehicles and methods for performing a prospective task based on a confidence in an accuracy of a module output. The vehicle identifies a prospective task to be performed by the vehicle, and obtains a confidence in an accuracy of an output of a module. The vehicle determines that the obtained confidence exceeds a threshold confidence that is associated with the prospective task, and in response to determining that the obtained confidence exceeds the threshold confidence, performs the prospective task.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method carried out by a vehicle, the method comprising:
identifying a prospective task to be performed by the vehicle;
obtaining a confidence in an accuracy of an output of a module;
determining that the obtained confidence exceeds a threshold confidence that is associated with the prospective task; and
in response to determining that the obtained confidence exceeds the threshold confidence, performing the prospective task.

2. The method of claim 1, wherein the prospective task comprises taking a given trajectory.

3. The method of claim 2, wherein taking the given trajectory comprises maintaining a current trajectory.

4. The method of claim 2, wherein taking the given trajectory comprises taking a trajectory different from a current trajectory.

5. The method of claim 1, wherein identifying the prospective task comprises detecting an action of a driver of the vehicle and predicting that the driver is attempting to cause the vehicle to perform the prospective task based on the detected action.

6. The method of claim 1, wherein the output of the module comprises a predicted trajectory of at least one of the vehicle and a road agent.

7. The method of claim 1, wherein:
the output of the module comprises a distribution of predicted trajectories,
the obtained confidence in the accuracy of the output of the module comprises a confidence in an accuracy of the distribution of the predicted trajectories, and
each predicted trajectory in the distribution is associated with a respective probability that at least one of the vehicle and a road agent will take the predicted trajectory.

8. The method of claim 1, wherein obtaining the confidence in the accuracy of the output of the module comprises selecting a module based on the prospective task and obtaining a confidence in an accuracy of an output of the selected module.

9. The method of claim 1, wherein performing the prospective task comprises causing the vehicle to perform the prospective task.

10. The method of claim 6, wherein:
the prospective task comprises taking a given trajectory, and
causing the vehicle to perform the prospective task comprises causing the vehicle to take the given trajectory.

11. The method of claim 1, wherein performing the prospective task comprises allowing the vehicle to perform the prospective task.

12. The method of claim 11, wherein:
the prospective task comprises taking a given trajectory, and allowing the vehicle to perform the prospective task comprises allowing the vehicle to take the given trajectory.

13. A vehicle comprising:
a processor; and
a non-transitory computer-readable storage medium comprising instructions that, when executed by the processor, cause the vehicle to:
identify a prospective task to be performed by the vehicle;
obtain a confidence in an accuracy of an output of a module;
determine that the obtained confidence exceeds a threshold confidence that is associated with the prospective task; and
in response to determining that the obtained confidence exceeds the threshold confidence, perform the prospective task.

14. The vehicle of claim 13, wherein:
the output of the module comprises a distribution of predicted trajectories,
the obtained confidence in the accuracy of the output of the module comprises a confidence in an accuracy of the distribution of the predicted trajectories, and
each predicted trajectory in the distribution is associated with a respective probability that at least one of the vehicle and a road agent will take the predicted trajectory.

15. The vehicle of claim 13, wherein the instructions that cause the vehicle to identify the prospective task comprises the instructions that cause the vehicle to detect an action of a driver of the vehicle and predict that the driver is attempting to cause the vehicle to perform the prospective task based on the detected action.

16. The vehicle of claim 13, wherein the instructions that cause the vehicle to perform the prospective task comprise instructions that cause the vehicle to allow the vehicle to perform the prospective task.

17. The vehicle of claim 16, wherein:
the prospective task comprises taking a given trajectory, and
the instructions that cause the vehicle to allow the vehicle to perform the prospective task comprise instructions that cause the vehicle to allow the vehicle to take the given trajectory.

18. A method carried out by a vehicle, the method comprising:
identifying a prospective task to be performed by the vehicle;
obtaining a confidence in an accuracy of an output of a module;
making a determination whether the obtained confidence exceeds a threshold confidence that is associated with the prospective task;
if the determination is that the obtained confidence exceeds the threshold confidence, performing the prospective task; and
if the determination is that the obtained confidence does not exceed the threshold confidence, performing an alternative task different from the prospective task.

19. The method of claim 18, wherein the alternative task comprises increasing the accuracy of the output of the module.

20. The method of claim 18, wherein:
the prospective task comprises taking a given trajectory, and
performing the alternative task comprises causing the vehicle to take an alternative trajectory different from the prospective trajectory.
